(19) United States
(12) Patent Application Publication
(10) Pub. No.: US 2008/0078677 A1
(43) Pub. Date: Apr. 3, 2008

(54) Testing Device For Precious Metals

(76) Inventors: Yih Jiun Chua, Singapore (SG); Kui Lim Tam, Singapore (SG)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/794,744

(22) PCT Filed: Nov. 9, 2006
(86) PCT No.: PCT/SG06/00341

§ 371 Date: Jul. 5, 2007

(30) Foreign Application Priority Data
Nov. 11, 2005 (SG) 200507368-9

(51) Int. Cl. G01N 27/28

(52) U.S. Cl. 204/406; 204/414

(57) ABSTRACT

A self contained testing device (100) for assaying precious metals includes a housing (110) for various mechanical and electronics components integrated to form a compact testing device. The testing device (100) includes a gel dispenser, e.g. syringe (200), an anode probe (650) to which may be attached a specimen holder (653) or crocodile clip (907), a cathode probe (624), and an electronic circuit (691) connected to the anode and cathode probes for conducting and recording tests. A sample (686) is held in the sample holder (653), e.g. by a spring clip (667), and gel is dispensed through a nozzle (115) to connect the specimen and cathode probe. The characteristics of the resulting cell are analysed and the results provided on a display (612).

### FIELD OF THE INVENTION

The present invention relates generally to a testing device for assaying precious metals.

### BACKGROUND OF THE INVENTION

There are various quantitative techniques to assay precious metals, in particular gold, including spectrometric, colorimetric and gravimetric techniques. One of the more commonly used technologies to assay gold is based on electrochemistry. Unlike the other techniques which are generally too complex, expensive or bulky to be used by most jewelers, e electrochemistry technique provides an easy and relatively inexpensive solution to assay gold.

For example, in the teaching of Medvinsky et al. of U.S. Pat. No. 4,799,999, an electrochemical process is used whereby a specimen is wetted by a described electrolyte and a small current anodizes the surface of the specimen. An external electronic measuring instrument is then applied to the charged surface, and potential difference decay is observed, tracked and analysed by the external measuring instrument. However, there are some inherent problems with such electrochemical testing equipment.

Typically, such testing equipment would include a syringe filled with hydrochloric acid solution. The hydrochloric acid solution in the syringe may be easily discharged as a result of inadvertent contact or pushing of the plunger.

The syringe is connected to a measuring instrument through lengthy wires. The set-up of such testing equipment is therefore cumbersome since various components have to be physically interconnected to one another.

When measurement is taken, it is necessary for the user to hold the syringe such that the nozzle of the syringe contacts the specimen (or the anode) for the period of the measurement. Therefore the testing equipment is not designed to be hands-free and the user has to engage the nozzle to ensure good contact with the specimen.

Furthermore, it may be difficult to deposit hydrochloric acid solution on an irregularly-shaped or uneven surface and so the taking of measurements in such circumstances can be very difficult.

The present invention aims to provide a novel electrolytic testing device for assaying precious metals that, in its various embodiments, may provide a number of advantages, and may address one or more of the above-mentioned problems.

### SUMMARY OF THE INVENTION

In accordance with the present invention, there is provided a self contained electrolytic testing device for assaying precious metals comprising:
a housing with a detachable sub-housing, said housing including an anode probe which in use is attachable to a first surface of a specimen under test and a cathode probe which in use is positioned in proximity to a second surface of the specimen;
a gel dispenser mounted partially within the sub-housing, said dispenser containing an electrolytic gel, and in use dispensing said electrolytic gel to electrically link the cathode probe to the second surface of the specimen; and
electrical circuitry mounted within the housing, said electrical circuitry in use generating and analysing current flow between the specimen, the electrolytic gel, the anode probe and the cathode probe.

Preferably, the testing device comprises a syringe having a plunger connected to a piston through a rod, said piston snugly fitting within the wall of the syringe.

Preferably, said testing device comprises a plunger that is mechanically coupled to a threaded section of a shaft, said plunger being displaceable by the rotation of the shaft.

Preferably, said rotation of the shaft is effected through a series of gears connected to a knob or a ratchet.

Preferably, said rotation of the shaft is effected through a knob or a ratchet acting directly on said shaft.

Preferably, said electrolytic gel is dispensed by turning a knob or a ratchet.

Preferably, said electrolytic gel is dispensed through a nozzle located on the housing's distal wall.

In accordance with another embodiment of the present invention, there is provided an electrolytic testing device for assaying precious metals, the device including:
a housing;
electronic circuitry mounted within the housing for testing a specimen;
a gel dispenser removably mounted within said housing for dispensing an electrolytic gel therefrom;
an actuator mechanism within said housing for actuating said gel dispenser so as to dispense electrolytic gel therefrom;
an anode probe connected to said electronic circuit for connection in use to a specimen; and
a cathode probe connected to said electronic circuit for connection in use to a specimen via gel dispensed from said gel dispenser.

Embodiments of the present invention may provide an integrated, self-contained, portable, electrolytic testing device for fast and easy assaying of precious metals. The devices may be lightweight and durable, and may provide hands-free use, prevent inadvertent dispensing of gel, and allow for the testing of irregularly-shaped specimens.

### BRIEF DESCRIPTION OF THE DRAWINGS

FIG. 1 shows the right side view of a preferred embodiment of a testing device and its housing and sub-housing;

FIG. 2 shows the top sectional view of the sub-housing;

FIG. 3 shows an embodiment of the arrangement of mechanical components within the sub-housing;

FIG. 4 shows an alternative embodiment of the arrangement of mechanical components within the sub-housing, with the sub-housing shown in the process of being mounted on the main housing;

FIG. 5 shows the top view of the testing device;

FIG. 6a shows the left side view of the testing device;

FIG. 6b shows the front view of the testing device;

FIG. 6c shows the back view of the testing device;

FIG. 7 shows the bottom view of the testing device;

FIG. 8a shows the front view of the spring clip with its handle removed.

FIG. 8b shows the front view of the handle.

FIG. 9 shows a close-up view on the front section of the left side view of the testing device;

FIG. 10 shows a close-up view on the front section of the left side view of the testing device and a detachable crocodile clip;

### PREFERRED EMBODIMENTS OF THE INVENTION

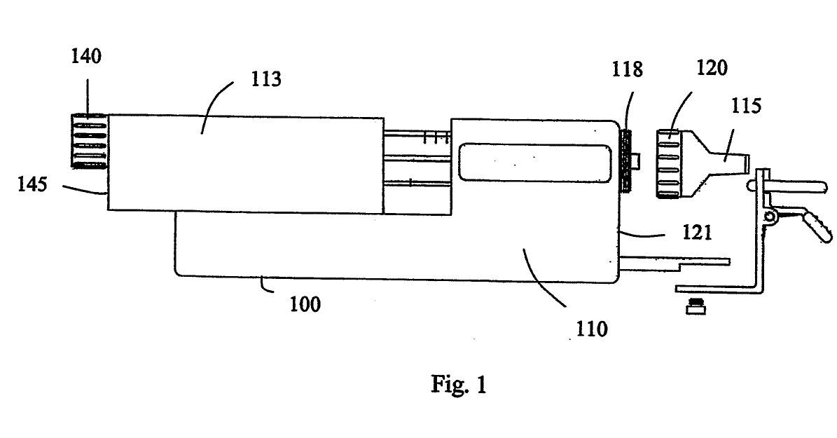

The testing device 100 as shown in FIG. 1 comprises a housing 110 to house various mechanical and electrical components needed for the functionality of the testing device 100. The housing 110 is preferably of an elongate rectangular shape to be conveniently held within one's palm.

A detachable sub-housing 113 is mounted onto the housing 110 to form a complete housing unit through, for example, a rail and groove type sliding mechanism although other coupling means may also be used. The housing 110 and sub-housing 113 are preferable made of lightweight and durable material, such as, for example, plastic or rubber material.

The housing 110 is adapted to include a nozzle 115 which is coupled to the distal wall 121 of the housing 110. The nozzle 115 may be coupled to the distal wall 121 of the housing 110 through a cylindrical protrusion 118. The cylindrical protrusion 118 may be formed as a molded feature of housing 110. Various means of coupling the nozzle 115 onto the cylindrical protrusion 118 may be used. For example, nozzle 115 and the cylindrical protrusion 118 may be screwed and tightened together. Alternatively, the base section 120 of the nozzle 115 may be bonded to the cylindrical protrusion 118 by adhesive means.

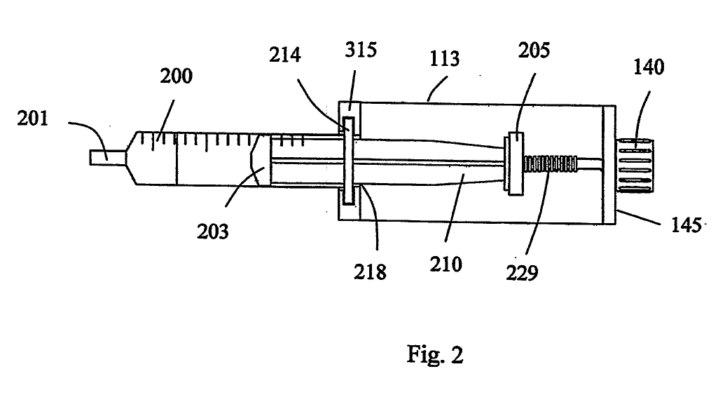

The sub-housing 113 has a gel dispenser/container, e.g. in the form of a syringe 200, located therein as shown in FIG. 2. Preferably, the syringe is made of a plastic material. Even more preferably, the syringe is made of a transparent plastic material.

The syringe 200 comprises a plunger 205 which is attached to a piston 203 through a rod 210, said piston being snugly fitted to the inside diameter of the cylindrical wall of the syringe 200. The syringe 200 comprises two openings, a spout 201 at its distal end from which gel may be dispensed and a proximal opening 218 through which the piston 203 may be inserted into the syringe.

The proximal opening 218 of syringe 200 is surrounded by a cylindrical flange 214. The body of the syringe 200 may be coupled to the sub-housing 113 by inserting the cylindrical flange 214 of the syringe 200 into a slot 315 which is formed on the bottom surface of the sub-housing 113 near the opening end of the sub-housing 113.

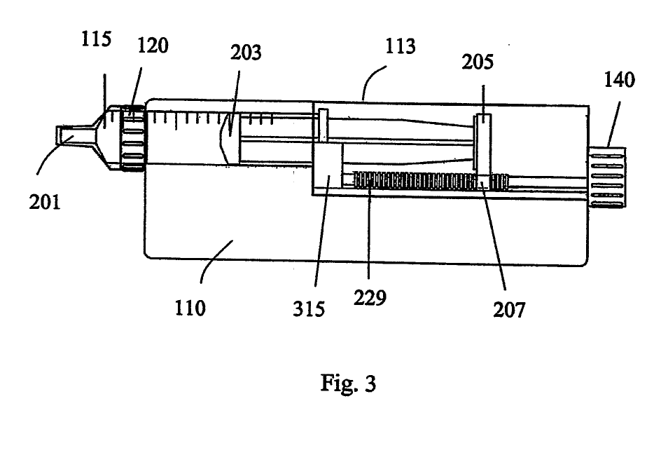

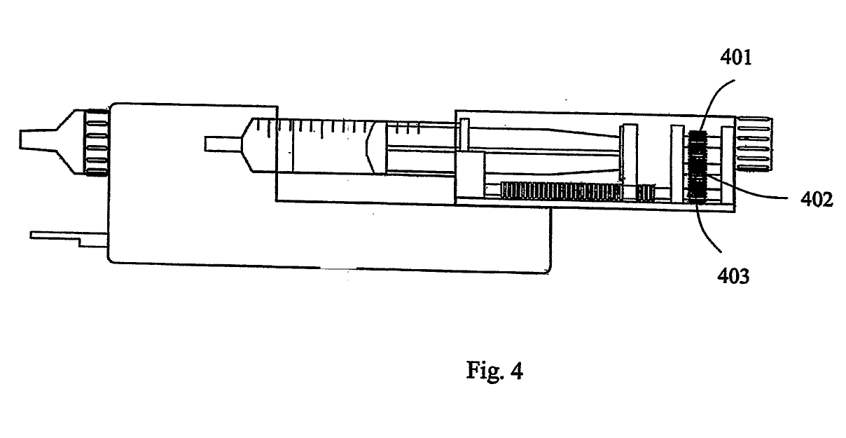

A knob 140 is coupled to the back wall of sub-housing 113 to control movement of the plunger 205, and so dispense an electrolytic gel contained within the syringe 200. The knob 140 actuates the plunger 140 via a shaft 229. The knob 140 may be coupled to shaft 229 directly, so that the knob 140 directly rotates the shaft 229 as shown in FIG. 3. Alternatively, the knob 140 may be coupled to shaft 229 through a series of gears 401, 402, 403 as shown in FIG. 4.

The use of the knob 140 and shaft 229, as well as optionally the gears, allow for accurate control of the amount of gel dispensed. The arrangement may also aid in safety, in that accidental dispensing of gel may be less likely to occur.

In a preferred embodiment of the invention, as shown in FIG. 3, the shaft 229 comprises a first end section which is coupled directly to knob 140, a middle section which is threaded and a last end section which is mounted into the back wall of slot 315. The shaft 229 is preferably located centrally at the bottom of the housing 113 and spanning between the back wall of slot 315 and knob 140. The shaft 229 may be rotated freely along a lateral axis between slot 315 and knob 140.

The lower section of plunger 205 comprises an opening 207, wherein its inner surface is threaded so that it may be coupled to the threaded section of shaft 229 by a screwing action. Therefore, when shaft 229 rotates, the plunger 205 which is mechanically coupled to the threaded section of the shaft 229 through opening 207 may be displaced forward or backward by the screwing motion of the shaft 229.

In another embodiment of the invention, the rotation of knob 140 may be restricted to only one direction by replacing the knob 140 with a ratchet.

Activation of the syringe may also take place using other mechanisms. For example, a pressure plate or other element could be provided in the sub-housing 113 to press on the plunger 205 to urge the piston 203 to dispense gel. The pressing element could for example be actuated using similar mechanisms to the knob 140 and shaft 229.

The syringe may also take any other suitable form, and could generally be replaced by any suitable dispensing device, e.g. having a gel reservoir, spout and actuator. The dispenser/syringe may be disposable or may be reusable, e.g. after being refilled.

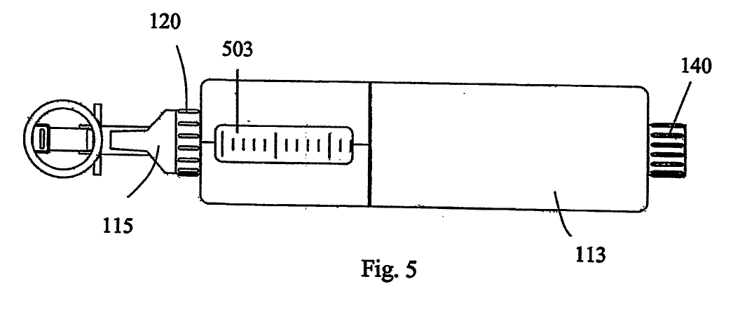

To allow a user to know when to replace the gel content of syringe 200, e.g. when the gel contained therein is nearing exhaustion, a transparent panel 503 may be placed for example, near the distal end of the top surface of the housing 110 as shown in FIG. 5. The transparent panel 503 may thereby serve as a visual gel level indicator. It is therefore preferably that at least the section of the syringe 200 toward the spout is made of a transparent material, such as for example, transparent plastic.

A syringe 200 may be refilled/replaced by sliding the sub-housing 113 off of the main housing 110, by removing the syringe 200 from the sub-housing 113, or by removing only the syringe body from the piston 203 and rod 210 for refilling. A new syringe, a refilled syringe or a refilled syringe body, may then be remounted in the sub-housing 113, and the sub-housing 113 remounted on the main housing 110.

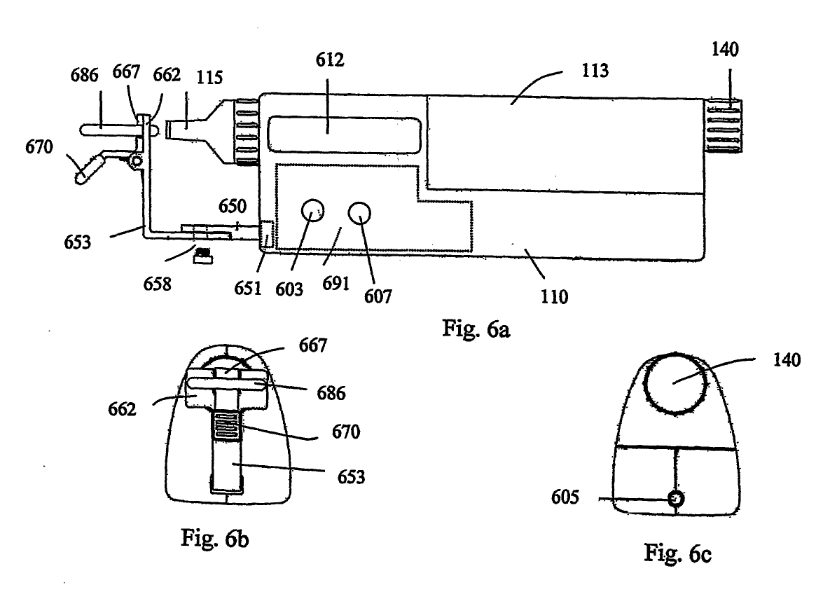

A switch 603 may be placed on the side wall of housing 110, preferably below an electronic display 612 to turn on or turn off the testing device 100 as shown in FIG. 6a. Another switch 607 may be placed beside switch 603 to start a new measurement cycle. A dc socket 605 may also be placed directly below the knob 140 to power the testing device. Locating the switches 603, 607 or dc socket 605 to other areas of the sub-housing 113 or the housing 110 may also be done.

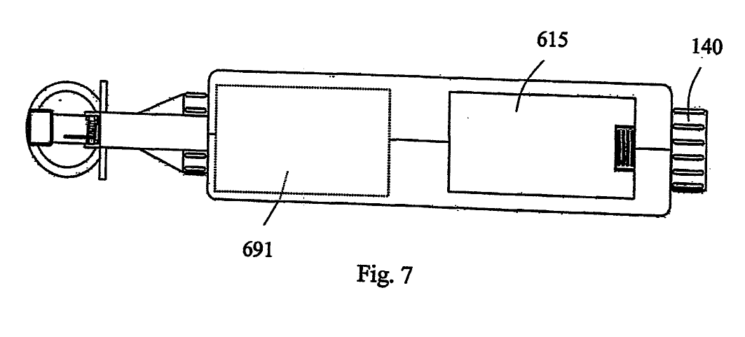

The testing device 100 may also be powered by a battery. To accommodate battery operation, a battery storage compartment 615 may be formed on the bottom of the housing 110, preferably near the proximal end of the housing 110 as shown in FIG. 7.

The battery and the dc socket 605 are electrically connected to an electric circuit board 691, the electric circuit board being shown in dotted lines in FIG. 6a and FIG. 7, and being mounted within the housing 110. Preferably, the electric circuit board 691 is mounted on the bottom of the housing 110, in proximity to the distal wall 121 of the housing 110.

The electric circuit board 691 comprises electronic components and a microprocessor for data processing and for carrying out specimen testing and measurements. The results of the testing and measuring are displayed on the electronic display 612. Preferably the electronic display 612 comprises a Liquid Crystal Display (LCD) device. Preferably, the LCD device is placed on the side wall of housing 110 near the nozzle 115 as shown in FIG. 6a. Even more preferably, two LCD devices are used, one on each side wall of housing 110. This conveniently allows a user to monitor the reading from any one side wall of the testing device 100.

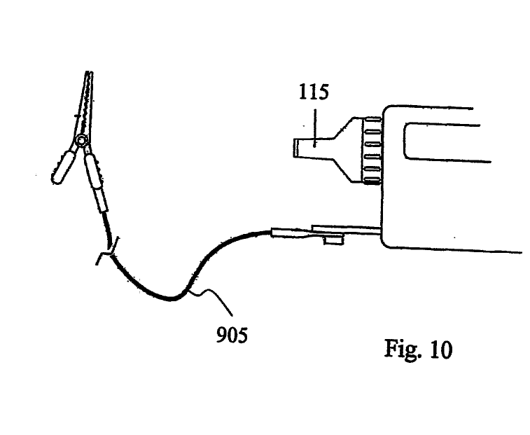

The testing device 100 also comprises a first arm 650 which serves as an anode probe as shown in FIG. 6. The first arm 650 is coupled to the lower section of the distal wall 121 of housing 110. To contact a specimen, the first arm 650 may be coupled to a specimen mounting device, e.g. a clip holder 653, as shown in FIG. 6. Alternatively, the first arm 650 may also be coupled to a crocodile clip cable 905 as shown in FIG. 10.

The first arm 650 includes a first end which comprises a base 651 which is slotted into a catch molded on the internal wall of the housing 110 to secure the base 651 firmly in place. In this way, the first arm 650 is securely coupled onto the distal wall 121 of the housing 110. The base 651 is electrically coupled to the electric circuit board 691 which is mounted within the housing 110. This electrical coupling may be done through, for example, soldering a conductive wire from the base 651 to an anode terminal of the electric circuit board 691. Preferably, the first arm 650 is made of stainless steel.

The second end of the first arm 650 may be coupled to the specimen clip holder 653 through hole 658. Various coupling means may be used. These include, for example, bolt and nut, Allan bolt or a screw.

The clip holder 653 comprises a first end which includes a spring clip 667 and a second end which is coupled to the first arm 650.

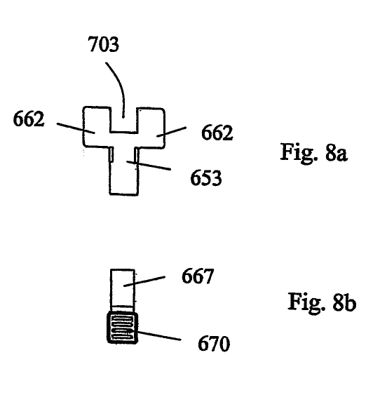

A specimen 686, comprising for example a gold ring, may be held in place by the spring clip 667, against an upper section member 662 of the holder 653, by opening or closing the spring clip 667 through handle 670. Preferably, the upper section member 662 of the specimen holder 653 acts as a shield/guard element and includes an opening 703, as shown in FIG. 8a, which provides a gap that allows only a section of the specimen 686 to be exposed to the nozzle 115 during measurement. The other adjacent body of the specimen 686 is blocked by the surrounding walls of member 662.

The specimen holder 653 could take other forms also. For example, it could be in the form of a clamping element, such as a screw clamp or the like.

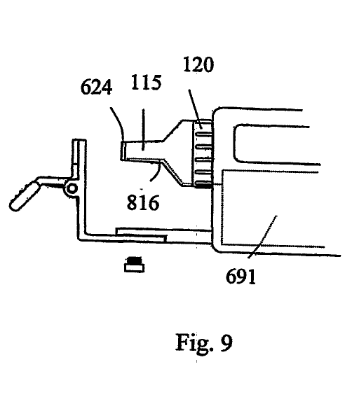

The tip end of nozzle 115 is adapted to include a cathode probe 624 which is electrically coupled to a cathode terminal of the electric circuit board 691 as shown in FIG. 9. Preferably, the cathode probe 624 comprises a flat circular disk which is coupled to the opening of the nozzle 115. Alternatively, a rounded circular ring may also be used.

The cathode probe 624 may be electrically connected to the cathode terminal of the electric circuit board 691 through for example, a strip of copper plate 816, as shown by dotted lines in FIG. 9. The copper plate 816 connects the cathode probe 624 to the electric circuit board 691 through an opening on the distal wall 121 of the housing 110. Preferably, the cathode probe 624 is made of platinum.

The cathode probe may also take other forms. It should generally be positioned adjacent the nozzle 115, and configured so that in use it is able to make electrical contact with a specimen under test via gel dispensed from the nozzle 115. The specimen, anode probe, electrolytic gel, and the cathode probe, then form a galvanic cell whose electrical characteristics may be analysed to assay the specimen.

The rigid specimen holder 653 may be detached from the first arm 650 and may be replaced by a flexible crocodile clip cable 905, as shown in FIG. 10. This alternative is particularly useful in testing bulky specimen, wherein the crocodile clip cable 905 may be conveniently and flexibly clipped and attached to the specimen during measurement.

To set-up the testing device 100, a first surface of the specimen 686 may be connected to an anode terminal. For example, the spring clip 667 of the specimen holder 653, which is mechanically and electrically coupled to the anode probe/first arm 650, may serve as an anode terminal. The clipping utility of the spring clip 667 advantageously provides a hands free functionality to the testing device 100.

A second surface of the specimen 686 is placed in close proximity to the cathode probe 624 which serves as a cathode terminal of the testing device 100. Preferably, the distance between the cathode probe 624 and the second surface of the specimen 686 ranges between 0.5 mm to 1 mm.

The specimen holder 653 has the advantage of allowing for accurate positioning of the specimen with respect to the nozzle 115 and the cathode probe 624.

A small quantity of electrolytic gel is dispensed through the nozzle 115 onto the specimen 686 by turning the knob 140. The electrolytic gel, when dispensed on the second surface of the specimen 686, physically and electrically links the cathode 624 to the second surface of the specimen 686. However, the first surface of the specimen is not in contact with the electrolytic gel.

Once the testing device 100 is turned on, a new cycle of measurement may be started by pressing switch 607. During measurement, current from the electric circuit board 691 flows through the electrodes (the anode and cathode probes 653 and 624), the specimen 686 and the electrolytic gel to produce an electrical characteristic which may be analysed by the microprocessor on the electric circuit board 191. The output or the result of the analysis may be displayed, for example, on the electronic display 612.

While the invention has been particularly shown and described with reference to various embodiments, it will be recognized by those skilled in the art that modifications and changes may be made to the present invention without departing from the spirit and scope thereof. The scope of the invention should therefore be determined not with reference to the above description but with reference to the appended claims along with their full scope of equivalents.

1-26. (canceled)

27. A self contained electrolytic testing device for assaying precious metals comprising:
a housing with a detachable sub-housing, the housing further comprising an anode probe, which in use is attachable to a first surface of a specimen under test, and a cathode probe, which in use is positioned in proximity to a second surface of the specimen;
a gel dispenser mounted partially within the sub-housing, the gel dispenser containing an electrolytic gel, and in use dispensing the electrolytic gel to electrically link the cathode probe to the second surface of the specimen; and
electrical circuitry mounted within the housing, the electrical circuitry in use generating and analyzing current flow among the specimen, the electrolytic gel, the anode probe and the cathode probe.

28. The testing device of claim 27, wherein the electrical circuitry comprises a plurality of terminals, the terminals comprising a cathode terminal operatively coupled with the cathode probe, an anode terminal operatively coupled with the anode probe, and an output data terminal operatively coupled with at least one electronic display.

29. The testing device of claim 28, wherein the electronic display comprises an LCD display.

30. The testing device of claim 27, wherein the gel dispenser comprises a syringe having a plunger connected to a piston through a rod, the piston snugly fitting within the wall of the syringe.

31. The testing device of claim 30, wherein the plunger is mechanically coupled to a threaded section of a shaft, the plunger being displaceable by rotation of the shaft.

32. The testing device of claim 31, wherein rotation of the shaft is effected through a series of gears connected to a knob or a ratchet.

33. The testing device claimed of claim 31, wherein rotation of the shaft is effected through a knob or a ratchet acting directly on the shaft.

34. The testing device of claim 27 wherein the electrolytic gel is dispensed through a nozzle located on a distal wall of the housing.

35. The testing device of claim 34, wherein the gel dispenser comprises a spout.

36. The testing device of claim 35, wherein the spout is inserted into the nozzle located on the distal wall of the housing.

37. The testing device of claim 36, wherein a tip end of the nozzle is adapted to include a cathode probe.

38. The testing device of claim 28, wherein the testing device comprises a first arm having a first end coupled to a distal wall of the housing, and a second end coupled to a specimen holder, and wherein the first arm is electrically coupled to the anode terminal of the electrical circuitry.

39. The testing device of claim 38, wherein the first arm and the specimen holder form an electrical linkage between the specimen and the anode terminal of the electrical circuitry.

40. The testing device of claim 39, wherein the specimen holder comprises a first end comprising a spring clip and a second end, the second end coupled to the first arm.

41. The testing device claimed in claim 40, wherein the specimen holder is adapted to expose only a section of a specimen to the cathode probe.

42. The testing device of claim 28, wherein the testing device comprises a first arm comprising a first end coupled to a distal wall of the housing and a second arm coupled to a crocodile clip cable, and wherein the first arm and the crocodile clip cable form an electrical linkage between the specimen and an anode terminal of the electrical circuitry.

43. The testing device of claim 27, wherein the housing comprises a gel level indicator on an external surface of the housing.

44. The testing device of claim 27, wherein the precious metals include gold, silver and titanium.

45. An electrolytic testing device for assaying precious metals, the device comprising:
a housing;
electronic circuitry mounted within the housing for testing a specimen;
a gel dispenser removably mounted within the housing for dispensing an electrolytic gel therefrom;
an actuator mechanism within the housing for actuating the gel dispenser so as to dispense electrolytic gel therefrom;
an anode probe connected to an electronic circuit for connection in use to a specimen; and
a cathode probe connected to the electronic circuit for connection in use to a specimen via gel dispensed from the gel dispenser.

46. An electrolytic testing device for assaying precious metals, the device comprising:
a housing comprising a nozzle;
a gel dispenser within the housing for dispensing electrolytic gel from the nozzle;
an anode probe;
a cathode probe adjacent the nozzle; and
electronic circuitry mounted within the housing and operatively connected to the anode probe and the cathode probe for testing a specimen, wherein the arrangement of the cathode probe and the nozzle is such that the cathode probe is capable of making an electrical connection with a specimen through gel dispensed from the nozzle, such that an electrical cell is formed by the anode probe, the specimen, the gel and the cathode probe.
